(19) United States
(12) Patent Application Publication
(10) Pub. No.: US 2016/0270402 A1
(43) Pub. Date: Sep. 22, 2016

(54) EMULSIFIABLE CONCENTRATE LIQUID COMPOSITIONS AND METHODS

(71) Applicant: AG PRECISION FORMULATORS, Middleton, WI (US)

(72) Inventors: KEITH R. ROWLEY, MADISON, WI (US); NONGNUCH SUTIVISEDSAK, MADISON, WI (US)

(21) Appl. No.: 15/073,962

(22) Filed: Mar. 18, 2016

Related U.S. Application Data
(60) Provisional application No. 62/134,938, filed on Mar. 18, 2015.

(51) Int. Cl. A01N 53/00; A01N 25/30; C05G 3/02; A01N 43/54

(52) U.S. Cl. CPC A01N 53/00; A01N 43/54; A01N 25/30; C05G 3/02

(57) ABSTRACT

Provided herein are compositions and methods for formulating and using agriculture products such as combinations of fertilizers and pesticides. For example, in some embodiments, provided herein are compositions and methods of their use comprising water miscible, organic solvents and water soluble anionic/non-ionic surfactants/emulsifiers that aid in the dissolution of an active substance. Such compositions provide formulations with high electrolyte tolerance and/or compatibility with a broad range of fertilizers.

The present application claims priority to U.S. Provisional Patent Application Ser. No. 62/134,938, filed Mar. 18, 2015, the disclosure of which is herein incorporated by reference in its entirety.

### FIELD

Provided herein are compositions and methods for formulating and using agriculture products such as combinations of fertilizers and pesticides.

### BACKGROUND

For conventional emulsifiable fungicide concentrates, such as HEADLINE EC (BASF), the active substance is dissolved in an oil-based solvent. When the concentrate is mixed with water, an emulsion (oil-in-water emulsion) is formed. An emulsifying agent formulated into the product helps prevent the emulsion from separating. A disadvantage of oil-based solvents is immiscibility with water when mixed with fertilizers in real world applications. Further, such formulations are incompatible with many fertilizer solutions.

Liquid fertilizers can also cause compatibility problems, mainly due to their strong electrochemical nature. As a result of mixing them with liquid pesticides, physical incompatibilities involving the active substances and inert ingredients of a pesticide and a fertilizer can affect the overall mixture become unstable, forming crystals, flakes, or sludge that may clog spray equipment. Furthermore, the deactivation of an active ingredient can occur with chemical incompatibility. Bad formulations, temperature, tank pH, and the length of the time held in a spray mixture in the tank prior use can all result in chemical incompatibility.

What is needed are improved formulations that facilitate the combination of agriculture products (e.g., pesticides, fungicides, insecticides, herbicides, plant growth regulators (PGRs), seed treatment products, etc.) with fertilizers for co-administration to plants.

### SUMMARY

Provided herein are compositions and methods for formulating and using agriculture products such as combinations of fertilizers and pesticides. For example, in some embodiments, provided herein are compositions, and methods of their use, comprising water miscible, organic solvents and water soluble anionic surfactants/emulsifiers that aid in the dissolution of an active substance. Such compositions provide formulations with high electrolyte tolerance and/or compatibility with starter fertilizers.

In some embodiments, provided herein are compositions comprising a mixture of an agricultural product, a solvent, and a surfactant. In some embodiments, the agriculture product is a pesticide, a fungicide (e.g., a strobilurin or strobilurin derivative (e.g., azoxystrobin, picoxystrobin, trifloxystrobin, kresoxim-methyl, orysastrobin, pyraclostrobin, dimoxystrobin, fluoxastrobin, metominostrobin, pyrametostrobin, pyrazoxystrobin, enestroburin, jiaxiangjunzhi, kresoxim-methyl, pyraclostrobin, and xiwojunan)), an insecticide, or an herbicide. In some embodiments, the solvent is an organic solvent. In some embodiments, the solvent is a water miscible solvent. In some embodiments, the solvent is selected from the group consisting of N-Methyl-Pyrrolidone, ethyl lactate, and Jeffsol AG1730. In some embodiments, the surfactant is an anionic, non-ionic, or cationic surfactant. In some embodiments, the surfactant is an ethoxylated phosphate ester-type surfactant or a tristyrylphenol ethoxylate surfactant.

In some embodiments, provided herein are compositions comprising a mixture of a fertilizer (e.g., a liquid fertilizer) or other plant growth agent (e.g., biostimulants (e.g., sea weed extract, fulvic acid, humic acid, amino acids); microbials; biologicals; inoculants; etc.) or combinations thereof (herein collectively referred to as “fertilizers”) with any of the above compositions.

Further provided herein a methods of treating a plant, seed, or soil, comprising: applying a fertilizer-containing composition as described above to a plant, seed, or soil. The application can be by any approach, including the use of application equipment (e.g., sprayer; liquid pumps and manifolds, planters, liquid starter systems; e.g., John Deere 1790 24R 20). In some embodiments, the fertilizer composition is mixed with seed, which are then subsequently planted.

### DETAILED DESCRIPTION

Provided herein are compositions and methods for formulating and using agriculture products such as combinations of fertilizers and pesticides. For example, in some embodiments, provided herein are compositions and methods of their use comprising water miscible, organic solvents and water soluble anionic surfactants/emulsifiers that aid in the dissolution of an active substance. Such compositions provide formulations with high electrolyte tolerance and/or compatibility with starter fertilizers.

In certain embodiments, an organic, water miscible solvent is mixed with a liquid, gas and/or solid comprising one or more active substances to form a dissolved mixture (e.g., completely dissolved mixture). In some embodiments, an emulsifier is added to help aid or improve the solubility of the active substance into the mixture and thus to prevent the settlement or precipitation when mixing with varieties of fertilizer solutions in agriculture applications. In some embodiments, the active substance is dissolved with one or more described solvents before the addition of one or more described emulsifiers. In some embodiments, the mixture can contain one or more active substances and then mixed in-can with one or more other active substances.

The present disclosure is not limited to any particular active substance that is mixed with the solvents. The principle mentioned can be employed with a variety of components as exemplified below.

The present disclosure further provides systems and methods of utilizing the compositions in agriculture, research, and landscaping applications.

### I. Compositions

Compositions of embodiments of the present disclosure comprise one or more or all of the following components: a) one or more agricultural products/active substances; b) one or more solvents; and c) one or more emulsifiers/surfactants. The compositions find use in combination with fertilizers (e.g., liquid fertilizers) to form a mixture comprising the above components and one or more fertilizers.

Exemplary, non-limiting examples of compositions, methods of formulating, and systems are described below.

### A. Agricultural Products/Active Substances

Embodiments of the present disclosure provide compositions comprising one or more agricultural products/active substances (e.g., herbicides, pesticides, or fungicides). Exemplary agricultural products are described below.

i. Fungicides

Examples of fungicides include, but are not limited to aliphatic nitrogen fungicides (e.g., butylamine, cymoxanil, dodicin, dodine, guazatine, iminoctadine); amide fungicides (e.g., carpropamid, chloraniformethan, cyflufenamid, diclocymet, ethaboxam, fenoxanil, flumetover, furametpyr, isopyrazam, mandipropamid, penthiopyrad, prochloraz, quinazamid, silthiofam, triforine, xiwojunan); acylamino acid fungicides (e.g., benalaxyl (e.g., benalaxyl-M), furalaxyl, metalaxyl (e.g., metalaxyl-M), pefurazoate, valifenalate); anilide fungicides (e.g., benalaxyl (e.g., benalaxyl-M), bixafen, boscalid, carboxin, fenhexamid, fluxapyroxad, isotianil, metalaxyl (e.g., metalaxyl-M), metsulfovax, ofurace, oxadixyl, oxycarboxin, penflufen, pyracarbolid, sedaxane, thifluzamide, tiadinil, vangard); benzanilide fungicides (e.g., benodanil, flutolanil, mebenil, mepronil, salicylanilide, tecloftalam); furanilide fungicides (e.g., fenfuram, furalaxyl, furcarbanil, methfuroxam); sulfonanilide fungicides (e.g., flusulfamide); benzamide fungicides (e.g., benzohydroxamic acid, fluopicolide, fluopyram, tioxymid, trichlamide, zarilamid, zoxamide); furamide fungicides (e.g., cyclafuramid, furmecyclox); phenylsulfamide fungicides (e.g., dichlofluanid, tolylfluanid); sulfonamide fungicides (e.g., amisulbrom, cyazofamid); valinamide fungicides (e.g., benthiavalicarb, iprovalicarb); antibiotic fungicides (e.g., aureofungin, blasticidin-S, cycloheximide, griseofulvin, kasugamycin, moroxydine, natamycin, polyoxins, polyoxorim, streptomycin, validamycin); aromatic fungicides (e.g., biphenyl, chlorodinitronaphthalenes, chloroneb, chlorothalonil, cresol, dicloran, hexachlorobenzene, pentachlorophenol, quintozene, sodium pentachlorophenoxide, tecnazene); arsenical fungicides (e.g., asomate, urbacide); aryl phenyl ketone fungicides (e.g., metrafenone, pyriofenone); benzimidazole fungicides (e.g., benomyl carbendazim, chlorfenazole, cypendazole, debacarb, fuberidazole, mecarbinzid, rabenzazole, thiabendazole); benzimidazole precursor fungicides (e.g., furophanate, thiophanate, thiophanate-methyl); benzothiazole fungicides (e.g., bentaluron, benthiavalicarb, benthiazole, chlobenthiazone, probenazole); botanical fungicides (e.g., allicin, berberine, carvacrol, carvone, osthol); bridged diphenyl fungicides (e.g., bithionol, dichlorophen, diphenylamine, hexachlorophene, parinol); carbamate fungicides (e.g., benthiavalicarb, furophanate, iprovalicarb, propamocarb, pyribencarb, thiophanate, thiophanate-methyl); benzimidazolylcarbamate fungicides (e.g., benomyl, carbendazim, cypendazole, debacarb, mecarbinzid); carbanilate fungicides (e.g., diethofencarb, lvdingjunzhi, pyraclostrobin, pyrametostrobin); conazole fungicides (e.g., conazole fungicides (imidazoles) (e.g., climbazole, clotrimazole, imazalil, oxpoconazole, prochloraz, triflumizole, see also imidazole fungicides), conazole fungicides (triazoles) (e.g., azaconazole, bromuconazole, cyproconazole, diclobutrazol, difenoconazole, diniconazole (e.g., diniconazole-M), epoxiconazole, etaconazole, fenbuconazole, fluquinconazole, flusilazole, flutriafol, furconazole (e.g., furconazole-cis), hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P, see also triazole fungicides)); copper fungicides (e.g., Bordeaux mixture, Burgundy mixture, Cheshunt mixture, copper acetate, copper carbonate, basic copper hydroxide, copper naphthenate, copper oleate, copper oxychloride, copper silicate, copper sulfate, copper sulfate, basic, copper zinc chromate, cufraneb, cuprobam, cuprous oxide, mancopper, oxine-copper, saisentong); cyanoacrylate fungicides (e.g., benzamacril, phenamacril); dicarboximide fungicides (e.g., famoxadone, fluoroimide); dichlorophenyl dicarboximide fungicides (e.g., chlozolinate, dichlozoline, iprodione, isovaledione, myclozolin, procymidone, vinclozolin); phthalimide fungicides (e.g., captafol, captan, ditalimfos, folpet, thiochlorfenphim); dinitrophenol fungicides (e.g., binapacryl, dinobuton, dinocap (e.g., dinocap-4, dinocap-6, meptyldinocap), dinocton, dinopenton, dinosulfon, dinoterbon, DNOC); dithiocarbamate fungicides (e.g., amobam, asomate, azithiram, carbamorph, cufraneb, cuprobam, disulfiram, ferbam, metam, nabam, tecoram, thiram, urbacide, ziram); cyclic dithiocarbamate fungicides (e.g., dazomet, etem, milneb); polymeric dithiocarbamate fungicides (e.g., mancopper, mancozeb, maneb, metiram, polycarbamate, propineb, zineb); dithiolane fungicides (e.g., isoprothiolane, saijunmao); fumigant fungicides (e.g., dithioether, methyl bromide); hydrazide fungicides (e.g., benquinox, saijunmao); imidazole fungicides (e.g., cyazofamid, fenamidone, fenapanil, glyodin, iprodione, isovaledione, pefurazoate, triazoxide, see also conazole fungicides (imidazoles)); inorganic fungicides (e.g., potassium azide, potassium thiocyanate, sodium azide, sulfur, see also copper fungicides, see also inorganic mercury fungicides); mercury fungicides (e.g., inorganic mercury fungicides (e.g., mercuric chloride, mercuric oxide, mercurous chloride), organomercury fungicides (e.g., (3-ethoxypropyl)mercury bromide, ethylmercury acetate, ethylmercury bromide, ethylmercury chloride, ethylmercury 2,3-dihydroxypropyl mercaptide, ethylmercury phosphate, N-(ethylmercury)-ptoluenesulphonanilide, hydrargaphen, 2-methoxyethylmercury chloride, methylmercury benzoate, methylmercury dicyandiamide, methylmercury pentachlorophenoxide, 8-phenylmercurioxyquinoline, phenylmercuriurea, phenylmercury acetate, phenylmercury chloride, phenylmercury derivative of pyrocatechol, phenylmercury nitrate, phenylmercury salicylate, thiomersal, tolylmercury acetate)); morpholine fungicides (e.g., aldimorph, benzamorf, carbamorph, dimethomorph, dodemorph, fenpropimorph, flumorph, tridemorph); organophosphorus fungicides (e.g., ampropylfos, ditalimfos, EBP, edifenphos, fosetyl, hexylthiofos, inezin, iprobenfos, izopamfos, phosdiphen, pyrazophos, tolclofos-methyl, triamiphos); organotin fungicides (e.g., decafentin, fentin, tributyltin oxide); oxathiin fungicides (e.g., carboxin, oxycarboxin); oxazole fungicides (e.g., dichlozoline, dingjunezuo, drazoxolon, famoxadone, hymexazol, metazoxolon, myclozolin, oxadixyl, vinclozolin); paclobutrazole; polysulfide fungicides (e.g., barium polysulfide, calcium polysulfide, potassium polysulfide, sodium polysulfide); pyrazole fungicides (e.g., bixafen, fluxapyroxad, furametpyr, isopyrazam, penflufen, penthiopyrad, pyraclostrobin, pyrametostrobin, pyraoxystrobin, rabenzazole, sedaxane); pyridine fungicides (e.g., boscalid, buthiobate, dingjunezuo, dipyrithione, fluazinam, 10 fluopicolide, fluopyram, lvdingjunzhi, parinol, pyribencarb, pyridinitril, pyrifenox, pyroxychlor, pyroxyfur); pyrimidine fungicides (e.g., bupirimate, diflumetorim, dimethirimol, ethirimol, fenarimol, ferimzone, nuarimol, triarimol); anilinopyrimidine fungicides (e.g., cyprodinil, mepanipyrim, pyrimethanil); pyrrole fungicides (e.g., dimetachlone, fenpiclonil, fludioxonil, fluoroimide); quinoline fungicides (e.g., ethoxyquin, halacrinate, 8-hydroxyquinoline sulfate, quinacetol, quinoxyfen, tebufloquin); quinone fungicides (e.g., benquinox, chloranil, dichlone, dithianon); quinoxaline fungicides (e.g., chinomethionat, chlorquinox, thioquinox); thiazole fungicides (e.g., ethaboxam, etridiazole, isotianil, metsulfovax, octhilinone, thiabendazole, thifluzamide); thiazolidine fungicides (e.g., flutianil, thiadifluor); thiocarbamate fungicides (e.g., methasulfocarb, prothiocarb); thiophene fungicides (e.g., ethaboxam, silthiofam); triazine fungicides (e.g., anilazine); triazole fungicides (e.g., amisulbrom, bitertanol, fluotrimazole, huanjunzuo, triazbutil, see also conazole fungicides (triazoles)); triazolopyrimidine fungicides (e.g., ametoctradin); urea fungicides (e.g., bentaluron, pencycuron, quinazamid); unclassified fungicides (e.g., acibenzolar, acypetacs, allyl alcohol, benzalkonium chloride, bethoxazin, bromothalonil, chloropicrin, DBCP, dehydroacetic acid, diclomezine, diethyl pyrocarbonate, ethylicin, fenaminosulf, fenitropan, fenpropidin, formaldehyde, furfural, hexachlorobutadiene, methyl iodide, methyl isothiocyanate, nitrostyrene, nitrothal-isopropyl, OCH, 2-phenylphenol, phthalide, piperalin, propamidine, proquinazid, pyroquilon, sodium orthophenylphenoxide, spiroxamine, sultropen, thicyofen, tricyclazole, zinc naphthenate).

In some embodiments, the fungicide is a strobilurin or strobilurin derivative. Strobilurins are part of the larger group of QoI inhibitors, which act to inhibit the respiratory chain at the level of Complex III. Azoxystrobin is one of the fungicidally known strobilurins, with the IUPAC name Methyl (2E)-2-(2-{[6-(2-cyanophenoxy)pyrimidin-4-yl]oxy}phenyl)-3-methoxyacrylate and unique registry number in Chemical Abstract System (CAS) of 131860-33-8. The molecular structure is represented by the following structure:

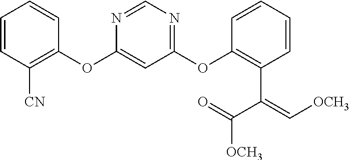 [SMILES: CO/C=C(/C(=O)OC)c1ccccc1Oc1cc(Oc2ccccc2C#N)ncn1]

Other strobilurins include, but are not limited to, picoxystrobin, trifloxystrobin, kresoxim-methyl, orysastrobin, pyraclostrobin, dimoxystrobin, fluoxastrobin, metominostrobin, pyrametostrobin, pyrazoxystrobin, enestroburin, jiaxiangjunzhi, kresoxim-methyl, pyraclostrobin, and xiwojunan.

ii. Insecticides

Examples of insecticides include, but are not limited to, antibiotic insecticides (e.g., allosamidin, thuringiensin); macrocyclic lactone insecticides (e.g., avermectin insecticides (e.g., abamectin, doramectin, emamectin, eprinomectin, ivermectin, selamectin), milbemycin insecticides (e.g., lepimectin, milbemectin, milbemycin oxime, and moxidectin), spinosyn insecticides (e.g., spinetoram and spinosad)); arsenical insecticides (e.g., calcium arsenate, copper acetoarsenite, copper arsenate, lead arsenate, potassium arsenite, sodium arsenite); botanical insecticides (e.g., allicin, anabasine, azadirachtin, carvacrol, d-limonene, matrine, nicotine, nornicotine, oxymatrine, pyrethrins (e.g., cinerins, (e.g., cinerin I, cinerin II), jasmolin I, jasmolin II, pyrethrin I, pyrethrin II), quassia, rhodojaponin-III, rotenone, ryania, sabadilla, triptolide); carbamate insecticides (e.g., bendiocarb, carbaryl); benzofuranyl methylcarbamate insecticides (e.g., benfuracarb, carbofuran, carbosulfan, decarbofuran, furathiocarb); dimethylcarbamate insecticides (e.g., dimetan, dimetilan, hyquincarb, isolan, pirimicarb, pyramat); oxime carbamate insecticides (e.g., alanycarb, aldicarb, aldoxycarb, butocarboxim, butoxycarboxim, methomyl, nitrilacarb, oxamyl, tazimcarb, thiocarboxime, thiodicarb, thiofanox); phenyl methylcarbamate insecticides (e.g., allyxycarb, aminocarb, bufencarb, butacarb, carbanolate, cloethocarb, CPMC, dicresyl, dimethacarb, dioxacarb, EMPC, ethiofencarb, fenethacarb, fenobucarb, isoprocarb, methiocarb, metolcarb, mexacarbate, promacyl, promecarb, propoxur, trimethacarb, XMC, xylylcarb); desiccant insecticides (e.g., boric acid, diatomaceous earth, silica gel); diamide insecticides (e.g., chlorantraniliprole, cyantraniliprole, flubendiamide); dinitrophenol insecticides (e.g., dinex, dinoprop, dinosam, DNOC); fluorine insecticides (e.g., barium hexafluorosilicate, cryolite, flursulamid, sodium fluoride, sodium hexafluorosilicate, sulfluramid); formamidine insecticides (e.g., amitraz, chlordimeform, formetanate, formparanate, medimeform, semiamitraz); fumigant insecticides (e.g., acrylonitrile, carbon disulfide, carbon tetrachloride, chloroform, chloropicrin, paradichlorobenzene, 1,2-dichloropropane, dithioether, ethyl formate, ethylene dibromide, ethylene dichloride, ethylene oxide, hydrogen cyanide, methyl bromide, methyl iodide, methylchloroform, methylene chloride, naphthalene, phosphine, sulfuryl fluoride, tetrachloroethane); inorganic insecticides (e.g., borax, boric acid, calcium polysulfide, copper oleate, diatomaceous earth, mercurous chloride, potassium thiocyanate, silica gel, sodium thiocyanate, see also arsenical insecticides, see also fluorine insecticides); insect growth regulators (e.g., chitin synthesis inhibitors (e.g., bistrifluron, buprofezin, chlorbenzuron, chlorfluazuron, cyromazine, dichlorbenzuron, diflubenzuron, flucycloxuron, flufenoxuron, hexaflumuron, lufenuron, novaluron, noviflumuron, penfluron, teflubenzuron, triflumuron); juvenile hormone mimics (e.g., dayoutong, epofenonane, fenoxycarb, hydroprene, kinoprene, methoprene, pyriproxyfen, triprene); juvenile hormones (e.g., juvenile hormone I, juvenile hormone II, juvenile hormone III); moulting hormone agonists (e.g., chromafenozide, furan tebufenozide, halofenozide, methoxyfenozide, tebufenozide, yishijing); moulting hormones (e.g., α-ecdysone, ecdysterone); moulting inhibitors (e.g., diofenolan); precocenes (e.g., precocene I, precocene II, precocene III); unclassified insect growth regulators (e.g., dicyclanil)); nereistoxin analogue insecticides (e.g., bensultap, cartap, polythialan, thiocyclam, thiosultap); nicotinoid insecticides (e.g., flonicamid); nitroguanidine insecticides (e.g., clothianidin, dinotefuran, imidacloprid, imidaclothiz, thiamethoxam); nitromethylene insecticides (e.g., nitenpyram, nithiazine); pyridylmethylamine insecticides (e.g., acetamiprid, imidacloprid, nitenpyram, paichongding, thiacloprid); organochlorine insecticides (e.g., bromo-DDT, camphechlor, DDT (e.g., pp′-DDT), ethyl-DDD, HCH (e.g., gamma-HCH, lindane), methoxychlor, pentachlorophenol, TDE); cyclodiene insecticides (e.g., aldrin, bromocyclen, chlorbicyclen, chlordane, chlordecone, dieldrin, dilor, endosulfan (e.g., alpha endosulfan), endrin, HEOD heptachlor, HHDN, isobenzan, isodrin, kelevan, mirex), organophosphorus insecticides (e.g., organophosphate insecticides (e.g., bromfenvinfos, calvinphos, chlorfenvinphos, crotoxyphos, dichlorvos, dicrotophos, dimethylvinphos, fospirate, heptenophos, methocrotophos, mevinphos monocrotophos, naled, naftalofos, phosphamidon, propaphos, TEPP, tetrachlorvinphos); organothiophosphate insecticides (e.g., dioxabenzofos, fosmethilan, phenthoate); aliphatic organothiophosphate insecticides (e.g., acethion, acetophos, amiton, cadusafos, chlorethoxyfos, chlormephos, demephion (e.g., demephion-O, demephion-S), demeton (e.g., demeton-O, demeton-S), demeton methyl (e.g., demeton-O-methyl, demeton-S-methyl), disulfoton, ethion ethoprophos, IPSP, isothioate, malathion, methacrifos, methylacetophos, oxydemetonmethyl, oxydeprofos, oxydisulfoton, phorate, sulfotep, terbufos, thiometon); aliphatic amide organothiophosphate insecticides (e.g., amidithion, cyanthoate, dimethoate, ethoate-methyl, formothion, mecarbam, omethoate, prothoate, sophamide, vamidothion), oxime organothiophosphate insecticides (e.g., chlorphoxim, phoxim, phoxim-methyl); heterocyclic organothiophosphate insecticides (e.g., azamethiphos, colophonate, coumaphos, coumithoate, dioxathion, endothion, menazon, morphothion, phosalone, pyraclofos, pyridaphenthion, quinothion); benzothiopyran organothiophosphate insecticides (e.g., dithicrofos, thicrofos); benzotriazine organothiophosphate insecticides (e.g., azinphos-ethyl, azinphos-methyl); isoindole organothiophosphate insecticides (e.g., dialifos, phosmet); isoxazole organothiophosphate insecticides (e.g., isoxathion, zolaprofos); pyrazolopyrimidine organothiophosphate insecticides (e.g., chlorprazophos, pyrazophos); pyridine organothiophosphate insecticides (e.g., chlorpyrifos, chlorpyrifos-methyl); pyrimidine organothiophosphate insecticides (e.g., butathiofos, diazinon, etrimfos, lirimfos, pirimioxyphos pirimiphos-ethyl, pirimiphos-methyl, primidophos, pyrimitate, tebupirimfos); thiadiazole organothiophosphate insecticides (e.g., athidathion, lythidathion, methidathion, prothidathion); triazole organothiophosphate insecticides (e.g., isazofos, triazophos); phenyl organothiophosphate insecticides (e.g., azothoate, bromophos, bromophos-ethyl, carbophenothion, chlorthiophos, cyanophos, cythioate, dicapthon, dichlofenthion, etaphos, famphur, fenchlorphos, fenitrothion, fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3, trifenofos, xiaochongliulin)); phosphonate insecticides (e.g., butonate, trichlorfon); phosphonothioate insecticides (e.g., mecarphon); phenyl ethylphosphonothioate insecticides (e.g., fonofos, trichloronat); phenyl phenylphosphonothioate insecticides (e.g., cyanofenphos, EPN, leptophos); phosphoramidate insecticides (e.g., crufomate, fenamiphos, fosthietan, mephosfolan, phosfolan, phosfolan-methyl pirimetaphos); phosphoramidothioate insecticides (e.g., dimefox, mazidox, mipafox, schradan); oxadiazine insecticides (e.g., indoxacarb); oxadiazolone insecticides (e.g., metoxadiazone); phthalimide insecticides (e.g., dialifos, phosmet, tetramethrin); pyrazole insecticides (e.g., chlorantraniliprole, cyantraniliprole, dimetilan, isolan, tebufenpyrad, tolfenpyrad); phenylpyrazole insecticides (e.g., acetoprole, ethiprole, fipronil, pyraclofos, pyrafluprole, pyriprole, vaniliprole); pyrethroid insecticides (e.g., pyrethroid ester insecticides (e.g., acrinathrin, allethrin (e.g., bioallethrin, esdépalléthrine), barthrin, bifenthrin, bioethanomethrin brofenvalerate, brofluthrinate, bromethrin, butethrin, chlorempenthrin, cyclethrin, cycloprothrin cyfluthrin (e.g., beta-cyfluthrin), cyhalothrin (e.g., gamma-cyhalothrin, lambda-cyhalothrin), cypermethrin (e.g., alpha-cypermethrin, beta-cypermethrin, theta-cypermethrin, zeta-cypermethrin), cyphenothrin, deltamethrin, dimefluthrin, dimethrin, empenthrin, d-fanshiluquebingjuzhi, fenfluthrin, fenpirithrin, fenpropathrin, fenvalerate (e.g., esfenvalerate), flucythrinate, fluvalinate (e.g., tau fluvalinate), furamethrin, furethrin, imiprothrin, japothrins, kadethrin, meperfluthrin, methothrin, metofluthrin, pentmethrin, permethrin (e.g., biopermethrin, transpermethrin), phenothrin, prallethrin, profluthrin, proparthrin, pyresmethrin, resmethrin (e.g., bioresmethrin, cismethrin), tefluthrin, terallethrin, tetramethrin, tetramethylfluthrin, tralocythrin, tralomethrin, transfluthrin, valerate; pyrethroid ether insecticides (e.g., etofenprox, flufenprox, halfenprox, protrifenbute, silafluofen); pyrethroid oxime insecticides (e.g., sulfoxime, thiofluoximate)); pyrimidinamine insecticides (e.g., flufenerim, pyrimidifen); pyrrole insecticides (e.g., chlorfenapyr); tetramic acid insecticides (e.g., spirotetramat); tetronic acid insecticides (e.g., spiromesifen); thiazole insecticides (e.g., clothianidin, imidaclothiz, thiamethoxam, thiapronil); thiazolidine insecticides (e.g., tazimcarb, thiacloprid); thiourea insecticides (e.g., diafenthiuron); urea insecticides (e.g., flucofuron, sulcofuron, see also chitin synthesis inhibitors); unclassified insecticides (e.g., closantel, copper naphthenate, crotamiton EXD, fenazaflor, fenoxacrim, hydramethylnon, isoprothiolane malonoben, metaflumizone, nifluridide, plifenate, pyridaben, pyridalyl, pyrifluquinazon, rafoxanide, sulfoxaflor, triarathene, triazamate).

iii. Pesticides

Examples of pesticides include, but are not limited to, acaricides, avicides, chemosterilants, herbicides, insecticides, molluscicides, plant growth regulators, virucides, algicides, bactericides, fungicides, insect attractants, mammal repellents, nematicides, rodenticides, antifeedants, bird repellents, herbicide safeners, insect repellents, mating disrupters, plant activators, synergists, chemical classes, and miscellaneous.

iv. Herbicides

The present disclosure is not limited to a particular herbicide. Examples include, but are not limited to, amide herbicides (e.g., allidochlor, amicarbazone, beflubutamid, benzadox, benzipram, bromobutide, cafenstrole, CDEA, cyprazole, dimethenamid (e.g., dimethenamid-P), diphenamid, epronaz, etnipromid, fentrazamide, flucarbazone, flupoxam, fomesafen, halosafen, huangcaoling, isocarbamid, isoxaben, napropamide, naptalam, pethoxamid, propyzamide, quinonamid, saflufenacil, tebutam); anilide herbicides (e.g., chloranocryl, cisanilide, clomeprop, cypromid, diflufenican, erlujixiancaoan, etobenzanid, fenasulam, flufenacet, flufenican, ipfencarbazone, mefenacet, mefluidide, metamifop, monalide, naproanilide, pentanochlor, picolinafen, propanil, sulfentrazone); arylalanine herbicides (e.g., benzoylprop, flamprop (e.g., flamprop-M)); chloroacetanilide herbicides (e.g., acetochlor, alachlor, butachlor, butenachlor, delachlor, diethatyl, dimethachlor, ethachlor, ethaprochlor, metazachlor, metolachlor (e.g., S-metolachlor), pretilachlor, propachlor, propisochlor, prynachlor, terbuchlor, thenylchlor, xylachlor); sulfonanilide herbicides (e.g., benzofluor, cloransulam, diclosulam, florasulam, flumetsulam, metosulam, perfluidone, pyrimisulfan, profluazol); sulfonamide herbicides (e.g., asulam, carbasulam, fenasulam, oryzalin, penoxsulam, pyroxsulam, see also sulfonylurea herbicides); thioamide herbicides (e.g., bencarbazone, chlorthiamid); antibiotic herbicides (e.g., bilanafos); aromatic acid herbicides (e.g., benzoic acid herbicides (e.g., chloramben, dicamba, 2,3,6-TBA, tricamba); pyrimidinyloxybenzoic acid herbicides (e.g., bispyribac, pyriminobac); pyrimidinylthiobenzoic acid herbicides (e.g., pyrithiobac); phthalic acid herbicides (e.g., chlorthal); picolinic acid herbicides (e.g., aminopyralid, clopyralid, picloram); quinolinecarboxylic acid herbicides (e.g., quinclorac, quinmerac)); arsenical herbicides (e.g., cacodylic acid, CMA, DSMA, hexaflurate, MAA, MAMA, MSMA, potassium arsenite, sodium arsenite); benzoylcyclohexanedione herbicides (e.g., ketospiradox, mesotrione, sulcotrione, tefuryltrione, tembotrione); benzofuranyl alkylsulfonate herbicides (e.g., benfuresate, ethofumesate); benzothiazole herbicides (e.g., benazolin, benzthiazuron, fenthiaprop, mefenacet, methabenzthiazuron); carbamate herbicides (e.g., asulam, carboxazole, chlorprocarb, dichlormate, fenasulam, karbutilate, terbucarb); carbanilate herbicides (e.g., barban, BCPC, carbasulam, carbetamide, CEPC, chlorbufam, chlorpropham, CPPC, desmedipham, phenisopham, phenmedipham, phenmedipham-ethyl, propham, swep); cyclohexene oxime herbicides (e.g., alloxydim, butroxydim, clethodim, cloproxydim, cycloxydim, profoxydim, sethoxydim, tepraloxydim, tralkoxydim); cyclopropylisoxazole herbicides (e.g., isoxachlortole, isoxaflutole); dicarboximide herbicides (e.g., cinidon-ethyl, flumezin, flumiclorac, flumioxazin, flumipropyn, see also uracil herbicides); dinitroaniline herbicides (e.g., benfluralin, butralin, chlornidine, dinitramine, dipropalin, ethalfluralin, fluchloralin, isopropalin, methalpropalin, nitralin, oryzalin, pendimethalin, prodiamine, profluralin, trifluralin); dinitrophenol herbicides (e.g., dinofenate, dinoprop, dinosam, dinoseb, dinoterb, DNOC, etinofen, medinoterb); diphenyl ether herbicides (e.g., ethoxyfen); nitrophenyl ether herbicides (e.g., acifluorfen, aclonifen, bifenox, chlomethoxyfen, chlornitrofen, etnipromid, fluorodifen, fluoroglycofen, fluoronitrofen, fomesafen, fucaomi, furyloxyfen, halosafen, lactofen, nitrofen, nitrofluorfen, oxyfluorfen); dithiocarbamate herbicides (e.g., dazomet, metam); halogenated aliphatic herbicides (e.g., alorac, chloropon, dalapon, flupropanate, hexachloroacetone, methyl bromide, methyl iodide, monochloroacetic acid, SMA, TCA); imidazolinone herbicides (e.g., imazamethabenz, imazamox, imazapic, imazapyr, imazaquin, imazethapyr); inorganic herbicides (e.g., ammonium sulfamate, borax, calcium chlorate, copper sulfate, ferrous sulfate, potassium azide, potassium cyanate, sodium azide, sodium chlorate, sulfuric acid); nitrile herbicides (e.g., bromobonil, bromoxynil, chloroxynil, dichlobenil, iodobonil, ioxynil, pyraclonil); organophosphorus herbicides (e.g., amiprofos-methyl, amiprophos, anilofos, bensulide, bilanafos, butamifos, 2,4-DEP, DMPA, EBEP, fosamine, glufosinate (e.g., glufosinate-P, glyphosate, huangcaoling piperophos); oxadiazolone herbicides (e.g., dimefuron, methazole, oxadiargyl, oxadiazon); oxazole herbicides (e.g., carboxazole, fenoxasulfone, isouron, isoxaben, isoxachlortole, isoxaflutole, methiozolin, monisouron, pyroxasulfone, topramezone); phenoxy herbicides (e.g., bromofenoxim, clomeprop, 2,4-DEB, 2,4-DEP, difenopenten, disul, erbon, etnipromid, fenteracol, trifopsime); phenoxyacetic herbicides (e.g., 4-CPA, 2,4-D, 3,4-DA, MCPA, MCPA-thioethyl, 2,4,5-T); phenoxybutyric herbicides (e.g., 4-CPB, 2,4-DB, 3,4-DB, MCPB, 2,4,5-TB); phenoxybutyric herbicides (e.g., 4-CPB, 2,4-DB, 3,4-DB, MCPB, 2,4,5-TB); phenoxypropionic herbicides (e.g., cloprop, 4-CPP, dichlorprop (e.g., dichlorprop-P), 3,4-DP, fenoprop, mecoprop (e.g., mecoprop-P); aryloxyphenoxypropionic herbicides (e.g., chlorazifop, clodinafop, clofop, cyhalofop, diclofop, fenoxaprop (e.g., fenoxaprop-P); fenthiaprop, fluazifop (e.g., fluazifop-P), haloxyfop (e.g., haloxyfop-P), isoxapyrifop, metamifop, propaquizafop, quizalofop (e.g., quizalofop-P), trifop); phenylenediamine herbicides (e.g., dinitramine, prodiamine); pyrazole herbicides (e.g., azimsulfuron, difenzoquat, halosulfuron, metazachlor, metazosulfuron, pyrazosulfuron, pyroxasulfone); pyrazole herbicides (e.g., benzofenap, pyrasulfotole, pyrazolynate, pyrazoxyfen, topramezone); phenylpyrazole herbicides (e.g., fluazolate, nipyraclofen, pinoxaden, pyraflufen); pyridazine herbicides (e.g., credazine, pyridafol, pyridate); pyridazinone herbicides (e.g., brompyrazon, chloridazon, dimidazon, flufenpyr, metflurazon, norflurazon, oxapyrazon, pydanon); pyridine herbicides (e.g., aminopyralid, cliodinate, clopyralid, diflufenican, dithiopyr, flufenican, fluroxypyr, haloxydine picloram, picolinafen, pyriclor, pyroxsulam, thiazopyr, triclopyr); pyrimidinediamine herbicides (e.g., iprymidam, tioclorim); pyrimidinyloxybenzylamine herbicides (e.g., pyribambenz-isopropyl, pyribambenzpropyl); quaternary ammonium herbicides (e.g., cyperquat, diethamquat, difenzoquat, diquat, morfamquat, paraquat); thiocarbamate herbicides (e.g., butylate, cycloate, diallate, EPTC, esprocarb, ethiolate, isopolinate, methiobencarb, molinate, orbencarb, pebulate, prosulfocarb, pyributicarb, sulfallate, thiobencarb, tiocarbazil, tri-allate, vernolate); thiocarbonate herbicides (e.g., dimexano, EXD, proxan); thiourea herbicides (e.g., methiuron); triazine herbicides (e.g., dipropetryn, fucaojing, trihydroxytriazine); chlorotriazine herbicides (e.g., atrazine, chlorazine, cyanazine, cyprazine, eglinazine, ipazine, mesoprazine, procyazine, proglinazine, propazine, sebuthylazine, simazine, terbuthylazine, trietazine); fluoroalkyltriazine herbicides (e.g., indaziflam, triaziflam); methoxytriazine herbicides (e.g., atraton, methometon, prometon, secbumeton, simeton, terbumeton); methylthiotriazine herbicides (e.g., ametryn, aziprotryne, cyanatryn, desmetryn, dimethametryn, methoprotryne, prometryn, simetryn, terbutryn); triazinone herbicides (e.g., ametridione, amibuzin, ethiozin, hexazinone, isomethiozin, metamitron, metribuzin); triazole herbicides (e.g., amitrole, cafenstrole, epronaz, flupoxam); triazolone herbicides (e.g., amicarbazone, bencarbazone, carfentrazone, flucarbazone, ipfencarbazone, propoxycarbazone, sulfentrazone, thiencarbazone); triazolopyrimidine herbicides (e.g., cloransulam, diclosulam, florasulam, flumetsulam, metosulam, penoxsulam, pyroxsulam); uracil herbicides (e.g., benzfendizone, bromacil, butafenacil, flupropacil, isocil, lenacil, saflufenacil, terbacil); urea herbicides (e.g., benzthiazuron, cumyluron, cycluron, dichloralurea, diflufenzopyr, isonoruron, isouron, methabenzthiazuron, monisouron, noruron); phenylurea herbicides (e.g., anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluron, phenobenzuron, siduron, tetrafluron, thidiazuron); sulfonylurea herbicides (e.g., pyrimidinylsulfonylurea herbicides (e.g., amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, metazosulfuron, methiopyrisulfuron, nicosulfuron, orthosulfamuron, oxasulfuron, primisulfuron, propyrisulfuron, pyrazosulfuron, rimsulfuron, sulfometuron, sulfosulfuron, trifloxysulfuron), triazinylsulfonylurea herbicides (e.g., chlorsulfuron, cinosulfuron, ethametsulfuron, iodosulfuron, metsulfuron, prosulfuron, thifensulfuron, triasulfuron, tribenuron, triflusulfuron, tritosulfuron)); thiadiazolylurea herbicides (e.g., buthiuron, ethidimuron, tebuthiuron, thiazafluron, thidiazuron); unclassified herbicides (e.g., acrolein, allyl alcohol, aminocyclopyrachlor, azafenidin, bentazone, bentranil, benzobicyclon, bicyclopyrone, buthidazole, calcium cyanamide, cambendichlor, chlorfenac, chlorfenprop, chlorflurazole, chlorflurenol, cinmethylin, clomazone, CPMF, cresol, cyanamide, ortho-dichlorobenzene, dimepiperate, dithioether, endothal, fluoromidine, fluridone, flurochloridone, flurtamone, fluthiacet, indanofan, methoxyphenone, methyl isothiocyanate, OCH, oxaziclomefone, pelargonic acid, pentachlorophenol, pentoxazone, phenylmercury acetate, prosulfalin, pyribenzoxim, pyriftalid, quinoclamine, rhodethanil, sulglycapin, thidiazimin, tridiphane, trimeturon, tripropindan, tritac).

In some embodiments, the herbicide is a commercially available herbicide formulation comprising one or more herbicides. Examples include, but are not limited to, those described in Table 1 below.

TABLE 1

| Herbicide | Active Ingredient | Company | Crop/Use |
|---|---|---|---|
| ANTHEM | Pyroxasulfone, fluthiacet-methyl | FMC | BURNDOWN/PRE |
| ANTHEM ATZ | Pyroxasulfone, fluthiacet-methyl, atrazine | FMC | BURNDOWN/PRE |
| AUTHORITY ASSIST | Sulfentrazone, imazethapyr | FMC | BURNDOWN/FALL |
| AUTHORITY MAXX | Sulfentrazone, chlorimuron ethyl | FMC | BURNDOWN/FALL |
| AUTHORITY MTZ | Sulfentrazone, metribuzin | FMC | BURNDOWN/FALL |
| AUTHORITY XL | Sulfentrazone, chlorimuron ethyl | FMC | BURNDOWN/FALL |
| AUTUMN SUPER | Thiencarbazone-methyl, iodosulfuron-methyl | BAYER | BURNDOWN/FALL |
| BALANCE FLEXX | Isoxaflutole | BAYER | BURNDOWN/PRE |
| BASIS BLEND | Rimsulfuron, thifensulfuron | DUPONT | CORN |
| CLARITY | Dicamba | BASF | BURNDOWN |
| COBRA | Lactofen | VALENT | SOYBEAN |
| CORVUS | Isoxaflutole, thiencarbazone | BAYER | BURNDOWN/PRE |
| DISTINCT | Dicamba, diflufenzopyr | BASF | BURNDOWN/FALL |
| FIRSTRATE | Cloransulam | DOW | SOYBEAN |
| FLEXSTAR | Fomesafen | SYNGENTA | SOYBEAN |
| GRAMOXONE SL 2.0 | Paraquat | SYNGENTA | BURNDOWN |
| HARMONY EXTRA | Thifensulfuron, Tribenuron | DUPONT | WHEAT |
| INSTIGATE | Rimsulfuron, mesotrione | DUPONT | BURNDOWN/PRE |
| LAUDIS | Tembotrione | BAYER | CORN |
| LEADOFF | Rimsulfuron, thifensulfuron | DUPONT | BURNDOWN/PRE |
| MARVEL | Fluthiacet, fomesafen | FMC | SOYBEAN |
| OLYMPUS FLEX | Propoxycarbazone-sodium, mesosulfuron-methyl | BAYER | WHEAT |
| OPTllL PRO | Saflufenacil, imazethyapyr, dimethanimd-P | BASF | BURNDOWN/PRE |
| PANOFLEX | Tribenuron, thifensulfuron | DUPONT | BURNDOWN |
| POAST PLUS | Sethoxydim | BASF | SOYBEAN |
| PURSUIT | Imazethapyr | BASF | SOYBEAN |
| RAPTOR | Imazamox | BASF | SOYBEAN |
| REFLEX | Fomesafen | SYNGENTA | SOYBEAN |
| RESOLVE Q | Rimsulfuron, thifensulfuron | DUPONT | CORN |
| RESOURCE | Flumiclorac | VALENT | SOYBEAN |
| RIMFIRE | Mesosulfuron-methyl, propoxycarbazone-sodium | BAYER | WHEAT |
| RIMFIRE MAX | Mesosulfuron-methyl, propoxycarbazone-sodium | BAYER | WHEAT |
| SHARPEN | Saflufenacil | BASF | BURNDOWN |
| STATUS | Dicamba, diflufenzopyr | BASF | CORN |
| SYNCHRONY XP | Chlorimuron-ethyl, thifensulfuron-methyl | DUPONT | SOYBEAN |
| VALOR | Flumioxazin | VALENT | BURNDOWN/PRE |
| VERDICT | Saflufenacil, dimethenamid-P | BASF | BURNDOWN/PRE |

### B. Solvents

The agricultural product/active substance is combined with one or more solvents. In some embodiments, the solvent is an organic solvent. In some embodiments, the solvent is a water miscible solvent. In some embodiments, the solvent is an organic, water miscible solvent. In some embodiments, the solvent has at least some water solubility (e.g., complete water solubility, substantially complete water solubility, detectable water solubility, solubility greater than 1, 50, 100, or 1000 mg/L, solubility greater than 1.0% solvent into water).

In some embodiments, the solvent is N-Methyl-Pyrrolidone (NMP, complete water solubility). In some embodiments, the solvent is ethyl lactate (complete water solubility). In some embodiments, the solvent is Jeffsol AG1730 (some water solubility).

### C. Surfactants/Emulsifiers

The agricultural product/active substance is combined with one or more surfactants/emulsifiers. In some embodiments, the surfactant/emulsifier is an anionic surfactant. In some embodiments, the surfactant/emulsifier is a non-ionic surfactant. In some embodiments, the surfactant/emulsifier is a cationic surfactant. Examples include, but are not limited to, ethoxylated phosphate ester type surfactants (e.g., STEPFAC 8180; Polyethylene glycol monotridecyl ether phosphate) and tristyrylphenol ethoxylates surfactants (e.g., TERMUL 3150).

### D. Fertilizers

The mixture comprising an agricultural product (e.g., pesticide) formulated with a solvent and a surfactant/emulsifier is combined with one or more fertilizers to provide a composition for applying to seeds or plants. Fertilizers include any micronutrient/fertilizer containing formulations that meet the definition of fertilizer as given by the AAPFCO (American Association of Plant Food Control Officials). Fertilizers include any material, whether of natural or synthetic origin, that is applied to soils or to plant tissues to supply one or more plant nutrients. Fertilizers include single nutrient (“straight”) fertilizers (e.g., ammonium nitrate, superphosphates, etc.) as well as multinutrient (e.g., binary (NP, NK, PK) fertilizers and NPK fertilizers) fertilizers (e.g., monoammonium phosphate, diammonium phosphate, etc.). Nutrients include but are not limited to nitrogen, phosphorus, potassium, calcium, magnesium, sulfur, copper, iron, manganese, molybdenum, zinc, boron, silicon, cobalt, and vanadium.

### E. Formulations

In some embodiments, the present disclosure provides agricultural formulations comprising one or more of the above described components in a variety of concentrations. Formulations may be provided as concentrates or as dilutions.

In some embodiments, the formulations comprise an agricultural product/active substance at its commercially useful concentration (or concentrate version thereof), e.g., 1% to 90% w/w. In some embodiments, the formulations further comprise a solvent (e.g., one or more solvents) concentration of 1% to 90% w/w. In some embodiments, the formulations further comprise an emulsifier/surfactant (e.g., one or more surfactants) concentration of 1% to 50% w/w. In some embodiments, the w/w % of the agricultural product represents the w/w % of a commercial formulation of the product as opposed to its pure chemical form. For example, SYNGENTA sells an azoxystrobin fungicide under the name QUADRIS which is 22.9% azoxystrobin and 77.1% other ingredients. In some embodiments, the w/w % above refers to the % of QUADRIS employed. In some embodiments, the w/w % above refers to the % azoxystrobin employed.

The above formulations may be mixed with fertilizer compositions (e.g., liquid fertilizer compositions). In some embodiments, the ratio of the mixture is 1:5 w/w % or v/v % (formulation:fertilizer); 1:10; 1:20; 1:50; 1:100; 1:500; 1:1000 or any ranges there in-between. In some embodiments, the formulation is mixed with a fertilizer composition such that the formulation makes up anywhere from 20% to 0.1% (by volume or by weight) of the final mixture.

The mixture of the formulations described herein with the fertilizer composition provides a final product that has enhanced properties relative to the same fertilizer composition mixed with traditional formulations employed with agricultural active substances. For example, the products provide herein are more stable, for example remaining useable without re-mixing for a longer period of time (e.g., greater than 30 minutes, greater than an hour). They also are amendable to re-mixing (e.g., indefinitely) or maintaining their form in circulation indefinitely. In particular, they reduce or avoid precipitation, the formation of oily material, and/or flocculation. They provide and maintain a clear (i.e., non-opaque) form, although perhaps colored. Batch-to-batch consistency is more reliable under a variety of conditions (handling, temperature, etc.).

### II. Uses

The compositions described herein find use in a variety of agricultural, research, home, and landscaping applications.

In some embodiments, compositions are provided in a kit or system in combination with a device for applying the composition or dilution thereof. In some embodiments, device is a sprayer or other application device. The particular choice of application device depends on the agricultural product, application, and scale of application (e.g., size of the plot or field that the agricultural product is applied to). A variety of systems for application of agricultural products are commercially available.

In some embodiments, compositions are applied by licensed or regulated operators. The use of certain herbicides or other agricultural products is regulated at the state level and regulations vary depending on the particular agricultural product and the state that it is being used in.

In some embodiments, the compositions described herein find use in agricultural application to prevent weeds, plant disease, pests, etc. The present disclosure is not limited to a particular agricultural crop. Examples include, but are not limited to, corn, soybeans, grain, and vegetables. In some embodiments, the herbicide composition is applied prior to seeding an agricultural crop, after an agricultural crop has emerged, or after harvest of an agricultural crop.

### EXAMPLES

The following examples are presented in order to provide certain exemplary embodiments of the present invention and are not intended to limit the scope thereof.

### Example 1

### Formulations of Azoxystrobin as an Active Substance in Formulation

Azoxystrobin-containing fungicide, typically is Suspension Concentrate (SC) formulated.

### EC Formulation:

A mixture of Azoxystrobin (a fungicide sold under the brand name AMISTAR) 23% w/w, N-Methyl-Pyrrolidone (NMP) 37% w/w, Jeffsol AG1730 (a solvent sold by HUNTSMAN) 27% w/w, and Stepfac 8180 (an ethoxylated phosphate ester sold by STEPAN) 13% w/w was prepared and mixed with a variety of liquid fertilizer compositions (see Table 1, below).

TABLE 2
Compatibility list at use rate 10 fl oz/acre

| | | | | use rate | Result |
|---|---|---|---|---|---|
| Item | GPA | Tank Mix Partner | Supplier | (fl oz/a) | Compatibilty |
| 1 | 5 | 10-34-0 | United Suppliers | | Yes |
| 2 | 5 | 1) 10-34-0 | United Suppliers | | |
| | | 2) Zn 9% EDTA Chelate (US, BASF supply) | United Suppliers | 32 | Yes |
| 3 | 5 | 1) 10-34-0 | United Suppliers | | |
| | | 2) Zince Chelate 10XL (Nulex) | United Suppliers | 32 | Yes |
| 4 | 5 | 1) 10-34-0 | United Suppliers | | |
| | | 2) Zince Nulex 20% | United Suppliers | 32 | Yes |
| 5 | 5 | 1) 10-34-0 | United Suppliers | | |
| | | 2) TJ Micromix | United Suppliers | 32 | Yes |
| 6 | 5 | 1) 10-34-0 | United Suppliers | | |
| | | 2) Corn Mix | United Suppliers | 32 | Yes |
| 7 | 4 | 1) 10-34-0 | United Suppliers | | |
| | | 2) Optistart Local | United Suppliers | 128 | Yes |
| 8 | 5 | Quad 5 (8-18-5-5S—0.5Zn—0.05Mn) | United Suppliers | | Yes |
| 9 | 5 | 6-24-6 (GoldStart, 80% orthophosphate) | Nutra-Flo | | Yes |
| 10 | 5 | 6-24-6 (Diamond, 100% orthophosphate) | Nutra-Flo | | Yes |
| 11 | 5 | 7-21-7 (orthophosphate) | Nutra-Flo | | Yes |
| 12 | 5 | 1) 10-34-0 | United Suppliers | | |
| | | 2) Capture LFR (Mark use 7 fl oz) | FMC | 6.7 | Yes |
| 13 | 5 | 1) 10-34-0 | United Suppliers | | |
| | | 2) Bifen 2AG Gold | Direct Ag Source | 5.12 | Yes |
| 14 | 5 | 1) 10-34-0 | United Suppliers | | |
| | | 2) Fanfare | MANA | 5.12 | Yes |
| 15 | 5 | 1) 10-34-0 | United Suppliers | | |
| | | 2) Discipline 2EC | AMVAC | 5.12 | Yes |
| 16 | 5 | Optistart Local | United Suppliers | | Yes |
| 17 | 5 | Optistart Pro | United Suppliers | | Yes |
| 18 | 5 | Optistart Gold | United Suppliers | | Yes |
| 19 | 5 | Optistart Gold Pro | United Suppliers | | Yes |

### Example 2

### Formulations of Bifenthrin as an Active Substance in EC Formulation (2EC)

### EC Formulation:

A mixture of Bifenthrin (a pyrethroid insecticide) 22.87% w/w, NMP 42.13% w/w, Jeffsol 1730 20% w/w, and Termul 3150 (an emulsifier sold by HUNTSMAN) 15% w/w was prepared and mixed with a variety of liquid fertilizer compositions.

The composition was shown to be compatible with 10-34-0, Optistart Gold, Optistart Pro, Optistart Gold Pro, and Optistart Local.

### Example 3

### EC Formulations of Bifenthrin at Lower Bifenthrin Concentrations (1.5EC)

A mixture of Bifenthrin 17.15% w/w, NMP 53.35% w/w, Jeffsol 1730 19.5% w/w, Termul 3150 10% w/w was prepared and mixed with a variety of liquid fertilizer compositions. The combination was also shown to be compatible with fertilizers in Table 2 with the exception of Optistart Local. Additional compatible fertilizers are as following:

TABLE 3
Compatibility list at use rate 7 fl oz/acre

| | | | | Use rate (fl | Result |
|---|---|---|---|---|---|
| Item | GPA | Tank Mix Partner | Supplier | oz/a) | Compatibility |
| 1 | 5 | 1) 10-34-0 | United Suppliers | | |
| | | 2) Zince Nulex 20% | | 32 | |
| | | 3) Optify | | 6 | Yes |
| 2 | 5 | 1) 10-34-0 | United Suppliers | | |
| | | 2) Optify | | 6 | Yes |
| 3 | 5 | 1) Optistart Pro | United Suppliers | | |
| | | 2) Optify | | 32 | Yes |
| 4 | 5 | 1) Optistart Gold Pro | United Suppliers | | |
| | | 2) Optify | | 6 | Yes |

### Example 4

### EC Formulations of Bifenthrin at Higher Bifenthrin Concentrations (3EC)

A mixture of Bifenthrin 34% w/w, NMP 26% w/w, Jeffsol 1730.20% w/w, Termul 3150 20% w/w was prepared and mixed with a variety of liquid fertilizer compositions. The combination was shown to be compatible with 10-34-0, Optistart Gold, Optistart Pro, Optistart Gold Pro, Optistart Local.

### Example 5

### Soybean Field Tests with Example 1 Formulation

Field tests were conducted with the formulation of Example 1 (“APF AZO”) for soybeans. Side-by-side comparisons were made against commercially available QUADRIS (Syngenta) and BIOMATE (Jhbiotech) products. 6-24-6 fertilizer (Nutra-Flo) was used. Seed treatment and rhizoctonia inoculation were employed.

The test samples employed were: 1) negative controls; 2) 6-24-6 alone; 3) APF alone (7 oz/a); 4) APF alone (14 oz/a); 5) APF-AZO (7 oz/a)+6-24-6 (1 gpa); 6) APF-AZO (14 oz/a); 7) QUADRIS (7 oz/a); 8) QUADRIS (14 oz/a); 9) BIOMATE (32 oz/a); and 10) BIOMATE+6-24-6 (32 oz/a:1 gpa).

A number of crop parameters were assessed, including stand count (at 13 and 24 days after planting); root fresh weight; root dry weight; foliage fresh weight; foliage dry weight; total fresh weight; total dry weight; root rot severity (%); and root rot incidence (%).

APF AZO at both 7 oz/a and 14 oz/a performed well on all measures. Both increased plant weights relative to the 6-24-6 control (the 7 oz/a providing better results than the 14 oz/a). Both provided superior plants weights to the QUADRIS treated plants and were generally comparable to the BIOMATE treated plants (in some cases lower, some cases higher, some the same). APF AZO at 7 oz/a provided the best results of all tested samples based on total dry weight. APF AZO at both 7 oz/a and 14 oz/a significantly reduced root rot severity % (14 oz/a providing the best result) compared to the negative controls and the 6-24-6 control and significantly outperformed the QUADRIS and BIOMATE treated plants. APF AZO 7 oz/a reduced root rot disease incidence % by about 35-45% compared to negative controls and the 6-24-6 control. It also performed significantly better than the QUADRIS and BIOMATE treated plants.

Thus, in addition to the advantages of avoiding precipitation, the formation of oily material, and/or flocculation, the APF AZO materials maintained or provided superior biological performance in managing plant growth and disease as compared to industry-leading products.

### Example 6

### Corn Field Tests with APF AZO

Field tests were conducted with the formulation of Example 1 (“APF AZO”) for corn. Tests were conducted at multiple different geographic locations having different climate and soil conditions. Side-by-side comparisons were made against commercially available QUADRIS (Syngenta). 10-34-0 and OPTISTART PRO (United Suppliers) fertilizers were used.

The test samples employed were: 1) negative control; 2) 10-34-0 alone (4.5 gal/a); 3) APF-AZO (7 oz/a)+10-34-0; 4) APF-AZO (14 oz/a)+10-34-0; 5) APF-AZO (21 oz/a)+10-34-0; 6) OPTISTART PRO alone (4.5 gal/a); 7) APF-AZO (7 oz/a)+OPTISTART PRO; 8) APF-AZO (14/oz/a)+OPTISTART PRO; 9) QUADRIS (7 oz/a); 10) QUADRIS (14 oz/a); 11) APF-AZO (7 oz/a) alone; and 12) APF-AZO (14/oz/a) alone.

A number of crop parameters were assessed, including corn plant population (plants per 35 ft), root dry weight, shoot dry weight, and yield.

The results, overall, showed that each of the APF-AZO concentrations outperformed the controls and were generally comparable to, or in some cases out-performed the QUADRIS treated plants. In general, the OPTISTART PRO combination with APF-AZO outperformed the 10-34-0 combination. APF-AZO was shown to be safe for use with corn (no significant injury observed).

### Example 7

### Corn Field Tests with APF Bifenthrin

Field tests were conducted with the formulation of Example 3 Bifenthrin insecticide (“APF-BFT”) combined with 10-34-0 fertilizer for corn treatment. Side-by-side comparisons were made against commercially available CAPTURE LFR (FMC)+10-34-0. Tests were conducted at multiple different geographic locations having different climate and soil conditions.

The test samples employed were: 1) negative control; 2) CAPTURE (6.8 oz/a)+10-34-0 (3 gal/a); 3) APF-BFT (6.8 oz/a)+10-34-0; and 4) APF-BFT (13.6 oz/a)+10-34-0.

A number of crop parameters were assessed, including root weight dry; shoot weight dry; and corn yield.

APF-BFT provides higher root and shoot weights than the control and provides comparable or superior weights to the CAPTURE-treated plants (the 6.8 oz/a APF-BFT generally provide superior performance to the 13.6 oz/a APF-BFT samples). Likewise, corn yields were generally comparable or superior to CAPTURE-treated plants. One of the field test site employed 27.2 oz of AFP-BFT in addition to the 6.8 and 13.6 oz tests. 27.2 provided better yield than the 13.6 oz, both of which were better than the 6.8 oz. In another site, the 6.8 oz outperformed the 13.6 oz.

Thus, the APF-BFT showed competitive performance and safety profiles compared to CAPTURE. CAPTURE is a suspension concentrate when mixed with fertilizer and therefore does not have the beneficial physical properties of the APF-BFT formulation. APF-BFT is easier to handle, does not settle out, and provides a more homogenous mixture with a broad range of fertilizers in general. APF-BFT has been be designed to spray foliarly, unlike CAPTURE.

We claim:

1. A composition comprising a mixture of an agricultural product, a solvent, and a surfactant.

2. The composition of claim 1, wherein said agricultural product is a pesticide.

3. The composition of claim 1, wherein said agricultural product is a fungicide.

4. The composition of claim 1, wherein said agriculture product is an insecticide.

5. The composition of claim 1, wherein said agriculture product is an herbicide.

6. The composition of claim 3, wherein said fungicide is a strobilurin or strobilurin derivative.

7. The composition of claim 6, wherein said strobilurin or strobilurin derivate is selected from the group consisting of azoxystrobin, picoxystrobin, trifloxystrobin, kresoxim-methyl, orysastrobin, pyraclostrobin, dimoxystrobin, fluoxastrobin, metominostrobin, pyrametostrobin, pyrazoxystrobin, enestroburin, jiaxiangjunzhi, kresoxim-methyl, pyraclostrobin, and xiwojunan.

8. The composition of claim 1, wherein said solvent is an organic solvent.

9. The composition of claim 8, wherein said solvent is a water miscible solvent.

10. The composition of claim 1, wherein said solvent is selected from the group consisting of N-Methyl-Pyrrolidone, ethyl lactate, and Jeffsol AG1730.

11. The composition of claim 1, wherein said surfactant is an anionic surfactant.

12. The composition of claim 1, wherein said surfactant is a non-ionic surfactant.

13. The composition of claim 1, wherein said surfactant is a cationic surfactant.

14. The composition of claim 1, wherein said surfactant is an ethoxylated phosphate ester-type surfactant.

15. The composition of claim 1, wherein said surfactant is a tristyrylphenol ethoxylate surfactant.

16. A composition comprising a mixture of a fertilizer and a composition of claim 1.

17. The composition of claim 16, wherein said fertilizer is a liquid fertilizer.

18. A method of treating a plant, seed, or soil, comprising: applying a composition of claim 16 to a plant, seed, or soil.

19. The method of claim 18, wherein said applying comprises use of application equipment.

20. The method of claim 18, wherein said applying comprises mixing a seed with said composition.
